(19) United States
(12) Patent Application Publication
(10) Pub. No.: US 2025/0216536 A1
(43) Pub. Date: Jul. 3, 2025

(54) Localization of Backscatter Devices

(71) Applicant: Cisco Technology, Inc., San Jose, CA (US)

(72) Inventors: Matthew Silverman, Shaker Heights, OH (US); Ardalan Alizadeh, Campbell, CA (US); Peiman Amini, Fremont, CA (US); Jerome Henry, Pittsboro, NC (US); Sivadeep R. Kalavakuru, Pleasanton, CA (US)

(21) Appl. No.: 18/939,891

(22) Filed: Nov. 7, 2024

Related U.S. Application Data
(60) Provisional application No. 63/616,436, filed on Dec. 29, 2023.

(51) Int. Cl. G01S 13/22; G01S 13/36

(52) U.S. Cl. CPC G01S 13/225; G01S 13/36

(57) ABSTRACT

Existing localization techniques for passive ambient backscatter devices may not be sufficient to perform accurate location detection, tracking, or providing location updates of the backscatter devices. To address this, devices and methods, and processes that facilitate improved localization of the backscatter devices are described herein. A network device in a network transmits a tone sequence to excite a backscatter device. At least one peer network device of a set of peer network devices communicatively coupled to the network device determines one or more phase difference values between the transmitted tone sequence received by the at least one peer network device and a reflected tone sequence received at the at least one peer network device from the excited backscatter device. The network device receives the one or more phase difference values and determines a location of the backscatter device.

This application claims the benefit of U.S. Provisional Patent Application No. 63/616,436, filed Dec. 29, 2023, which is incorporated by reference herein in its entirety.

The present disclosure relates to communication networks. More particularly, the present disclosure relates to localization of backscatter devices in a communication network.

### BACKGROUND

In recent years, advancements in passive communication devices have introduced new possibilities for tracking objects and enhancing Internet-of-Things (IoT) applications. Among these devices are Ambient (AMP) Backscatter devices (BKDs), also referred to as Backscatter Devices (BKDs), which utilize low-energy communication by reflecting rather than generating Radio Frequency (RF) signals. Unlike traditional wireless devices such as those adhering to the IEEE 802.11 Wi-Fi standard, BKDs do not actively transmit signals. Instead, BKDs reflect RF energy, which is detectable by surrounding RF sources such as energizing Access Points (APs). A typical AMP backscatter system may include an energizing AP as the RF source and a separate receiver AP, which together facilitate detection of a BKD's location. However, the passive nature of AMP BKDs may introduce various challenges in precise localization.

Traditional localization methods, such as Received Signal Strength Indicator (RSSI)-based techniques, may rely on active signal transmission from a device to estimate position. Since a BKD reflects rather than transmits signals, RSSI-based localization may be heavily influenced by the distance between the APs rather than by the BKD's location. Additionally, beamforming techniques may introduce signal variability, adding further complications to precise BKD localization. Other localization techniques, for example, Time-of-Flight (ToF) or Hybrid Angle and Distance Measurement (HADM), also struggle with BKDs due to their passive nature, limited protocol participation, and multi-path reflections. Techniques such as beam-sweeping, where directed beams scan across spaces to pinpoint devices, may be hindered by weak or sporadic reflections from BKDs and environmental interference (e.g., signal scattering), which can distort paths and introduce noise. Thus, there are opportunities to enhance location detection for BKDs.

### SUMMARY OF THE DISCLOSURE

Devices and methods for facilitating localization of backscatter devices in accordance with embodiments of the disclosure are described herein.

In many embodiments, a network device may include a network controller, a processor, and a memory. The network controller may be configured to provide access to a network and be communicatively coupled to a set of peer network devices. The memory may be coupled to the processor and may include a location detection logic that is configured to transmit a tone sequence to excite a backscatter device (BKD). The location detection logic may further be configured to receive, from at least one peer network device of the set of peer network devices, one or more phase difference values between the transmitted tone sequence received by the at least one peer network device and a reflected tone sequence the at least one peer network device received from the excited BKD. Furthermore, the location detection logic may further be configured to determine a location of the BKD based on the received one or more phase difference values.

In a variety of embodiments, prior to transmitting the tone sequence, the location detection logic may further be configured to transmit an announcement frame.

In a number of embodiments, the announcement frame may include an identifier of the at least one peer network device and an identifier of the BKD.

In further embodiments, the announcement frame may correspond to an indication to the at least one peer network device to participate in a location determination event of the BKD.

In several embodiments, the announcement frame may further include one or more of: a target time, a target channel, or a target duration.

In additional embodiments, based on the announcement frame comprising the target time, the location detection logic may be further configured to transmit the tone sequence at the target time.

In more embodiments, based on the announcement frame comprising the target duration, the location detection logic may be further configured to transmit the tone sequence for the target duration.

In numerous embodiments, based on the announcement frame comprising the target channel, the location detection logic may be further configured to transmit the tone sequence on the target channel.

In various embodiments, the announcement frame may further include information corresponding to the tone sequence.

In one or more embodiments, the information corresponding to the tone sequence may include at least one of a frequency hopping pattern associated with the tone sequence, or a duration of symbols in each tone of the tone sequence.

In yet more embodiments, the announcement frame may include an action frame.

In still more embodiments, to transmit the tone sequence, the location detection logic may be further configured to sequentially transmit a plurality of tones.

In still yet more embodiments, the plurality of tones may include non-data bearing tones.

In many further embodiments, the plurality of tones may be phase consistent.

In several more embodiments, a peer network device may include a processor, a network interface controller configured to provide access to a network, and a memory communicatively coupled to the processor. The memory may include a location detection logic that is configured to receive a tone sequence from a network device and a reflected tone sequence from a BKD. The location detection logic may be further configured to determine one or more phase difference values between the received tone sequence and the received reflected tone sequence, and transmit the one or more phase difference values to the network device.

In many additional embodiments, prior to receiving the tone sequence and the reflected tone sequence, the location detection logic may be further configured to receive an announcement frame comprising at least one of: a target time, a target duration, or a target channel associated with a location determination event of the BKD.

In many more embodiments, based on the announcement frame including the target time, the target duration, and the target channel, the location detection logic is further configured to transmit at the target time, a null frame with a duration field set for the target duration on the target channel.

In several additional embodiments, based on receiving the announcement frame, the location detection logic may be further configured to tune to the target channel at the target time, wherein the tone sequence and the reflected tone sequence may be received on the target channel.

In numerous additional embodiments, a backscatter device may include an antenna and a location detection logic. The location detection logic may be configured to receive a tone sequence including a plurality of tones. The plurality of tones may be consistent in phase. The location detection logic may further be configured to create, based on impedance modulation of the antenna, an on/off keying pattern in synchronization with the phase of the plurality of tones, and reflect the tone sequence based on the on/off keying pattern.

In various additional embodiments, the backscatter device may be a passive backscatter device that excites based on the received tone sequence.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that implement a location detection logic in accordance with various embodiments of the disclosure;

FIG. 2 is a schematic block diagram of an example communication network implementing localization of a backscatter device (BKD) in accordance with various embodiments of the disclosure;

FIG. 3 is a schematic flow diagram that illustrates a format of an example announcement frame in accordance with various embodiments of the disclosure;

FIG. 4 is a schematic flow diagram that illustrates a location determination event of a BKD in accordance with various embodiments of the disclosure;

FIG. 5 is a flowchart depicting a process for localization of a BKD in accordance with various embodiments of the disclosure;

FIG. 6 is a flowchart depicting a process for a location determination event in accordance with various embodiments of the disclosure;

FIG. 7 is a flowchart depicting a process for determining measurement data during a location determination event of a BKD in accordance with various embodiments of the disclosure;

FIG. 8 is a flowchart depicting a process for determining measurement data during a location determination event of a BKD in accordance with various embodiments of the disclosure;

FIG. 9 is a flowchart depicting a process for reflecting a tone sequence by a BKD in accordance with various embodiments of the disclosure; and

FIG. 10 is a conceptual block diagram of a device suitable for configuration with a location detection logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate localization of backscatter devices (BKDs). Ambient (AMP) BKDs, also referred to simply as BKDs, operate differently from traditional wireless devices such as those adhering to the IEEE 802.11 Wi-Fi standard. For example, rather than actively transmitting signals, generating timestamps, or engaging in two-way ranging, BKDs reflect Radio Frequency (RF) energy, which may be detectable by surrounding RF sources such as energizing Access Points (APs). Traditional localization methods such as Received Signal Strength Indicator (RSSI)-based methods may, therefore, be unreliable, as RSSI depends on AP distance rather than a BKD's position. Other techniques such as Time-of-Flight (ToF), Hybrid Angle and Distance Measurement (HADM), etc., may also be ineffective, as these techniques require active device responses that BKDs are unable to provide. Techniques, such as beam-sweeping, that do not demand active device responses may also be hindered by weak or sporadic reflections from BKDs and environmental interference (e.g., signal scattering), which can distort paths and introduce noise. Therefore, there is a significant potential to improve localization methods for locating BKDs, and achieve precise and reliable tracking.

The present disclosure provides a network device that may facilitate accurate localization of BKDs. The network device can be a primary AP, a reference AP, an energy source, a triggering AP, a wireless Local Area Network (LAN) controller (WLC), or the like. The network device may enable precise location tracking within a wireless network for the BKDs. The wireless network may include the network device, a set of peer network devices (e.g., peer APs, anchors, secondary APs, neighboring APs, receiving APs, participating APs, or the like), and the BKDs. “BKDs” may refer to passive devices that reflect existing RF signals instead of actively transmitting the RF signals. The BKDs may modulate their antenna impedance to create on-off keying patterns detectable by APs in the wireless network. Examples of the BKDs may include Radio Frequency Identification (RFID) tags, battery-free Internet-of-Things (IoT) sensors, Near Field Communication (NFC) payment cards, electronic toll tags, smart packaging labels, or the like.

In many embodiments, the network device may include a network controller configured to provide access to the wireless network. The network controller may be communicatively coupled to the set of peer network devices. The network device may further include a processor and a memory communicatively coupled to the processor. The memory may include a location detection logic. In some embodiments, the location detection logic can be external to the network device or embodied as a standalone component within the network device. In certain embodiments, the location detection logic may further be a standalone device working as a location server and communicatively coupled to the network device and the set of peer network devices.

In a variety of embodiments, the network device may be configured to locate and track at least one BKD in the wireless network. To enable the localization of the BKD, in various embodiments, the network device may transmit an announcement frame to announce an intent of the network device to perform a location determination event for the BKD at a target time. The announcement frame may be an action frame and may be referred to as an “Action for Multi-Point Localization Announcement (AMPLA)”. The announcement frame can be transmitted to a known multicast address of the set of peer network devices. Additionally, the announcement frame can be broadcasted to the set of peer network devices as an indication to at least one peer network device of the set of peer network devices to participate in the location determination event. In more embodiments, the at least one peer network device may be configured to receive the announcement frame from the network device and may respond with an acknowledgement to participate in the location determination event.

In many more embodiments, the announcement frame may communicate information about the location determination event to the at least one peer network device, enabling the at least one peer network device to synchronize its operations for accurate localization. The information communicated in the announcement frame may include an identifier of the at least one peer network device, an identifier of the BKD, the target time, a target channel, a target duration, information corresponding to a tone sequence to be transmitted to excite the BKD, or the like. For example, the identifier of the at least one peer network device may indicate which peer network device(s) are designated to participate in the location determination event. Further, the identifier of the BKD may be included in the announcement frame to ensure that the correct BKD is targeted or tracked during the location determination event. Additionally, the target time may be included in the announcement frame to notify the at least one peer network device regarding an execution time for the location determination event. Further, the target channel may be included in the announcement frame to indicate which frequency channel is intended to be utilized for the location determination event, and the target duration may be provided to define for how long the location determination event may last. The target duration may be set long enough to allow the at least one peer network device to temporarily leave a corresponding active channel and switch to the target channel for participating in the location determination event. Further, the target duration may be set to allow the BKD enough time to reflect the transmitted tone sequence and generate an appropriate signal for localization. Furthermore, the information corresponding to the tone sequence may include various parameters characterizing the tone sequence, for example, an order, a frequency, or a phase of a plurality of tones in the tone sequence, a frequency hopping pattern associated with the tone sequence, a duration of symbols in each tone of the tone sequence, or the like.

In a number of embodiments, the network device may transmit the tone sequence to excite the BKD, at the target time for the target duration on the target channel specified in the announcement frame. Thus, the tone sequence may serve as an energizing signal for the BKD. “Tone sequence” may include the plurality of tones, a series of RF tones or signals, each with specific frequencies, phases, or durations, transmitted sequentially in an order. The plurality of tones may include non-data bearing tones and may be phase consistent. “Non-data bearing tones” may refer to RF signals that carry no payload or meaningful data and serve to energize passive devices such as BKDs by triggering reflections. In one or more embodiments, the tone sequence may include serially decreasing or serially increasing frequencies with consistent phase. For example, the plurality of tones in the tone sequence may exhibit a monotonic progression, either ascending from low to high or descending from high to low, consistent in phase. In many other embodiments, the tone sequence may incorporate a frequency hopping pattern or a random pattern in the plurality of tones, while maintaining consistent phase among the plurality of tones.

In several embodiments, at the target time, the at least one peer network device may tune to the target channel specified in the announcement frame and begin listening for the tone sequence. For example, if the at least one peer network device is tuned to a different channel, the at least one peer network device may switch from the different channel to the target channel as the target time approaches. That is, the at least one peer network device may configure one or more radios to listen to the target channel. In further embodiments, the at least one peer network device may be configured to transmit at the target time, a null frame with a duration field set for the target duration on the target channel to quiet the target channel during the location determination event. In several more embodiments, upon tuning to the target channel, the at least one peer network device may be configured to receive the tone sequence from the network device at the target time on the target channel.

In numerous embodiments, the BKD may include an antenna configured to receive the tone sequence (e.g., the plurality of tones) at the target time. The BKD hardware may react to energy received in the tone sequence, and create, based on impedance modulation of the antenna, an on/off keying pattern in synchronization with the phase of the plurality of tones. The BKD may reflect the tone sequence based on the on/off keying pattern.

In yet various embodiments, the at least one peer network device may receive the reflected tone sequence from the BKD on the tuned target channel. In still further embodiments, upon receiving the reflected tone sequence, the at least one peer network device may determine one or more phase difference values between the received tone sequence and the received reflected tone sequence and may transmit the one or more phase difference values to the network device. In an example, a phase difference value corresponding to a tone of the plurality of tones may indicate a slope of the phase differences between the received tone and the received reflected tone. In numerous additional embodiments, the at least one peer network device may transmit the one or more phase difference values to the network device in an action frame. In many additional embodiments, the network device may also receive one or more phase difference values from other designated peer network devices in addition to the peer network device.

In still numerous embodiments, an additional set of location anchors may be placed more densely along with the set of peer network devices relative to the network device to enhance the accuracy of the location detection of the BKD, especially when there are multiple BKDs in the vicinity. In still yet more embodiments, the additional set of location anchors may also receive the tone sequence from the network device and the reflected tone sequence from the BKD. The additional set of location anchors may further transmit one or more phase difference values between the tone sequence received from the network device and the reflected tone sequence received from the BKD to the network device. In many additional embodiments, the additional set of location anchors may utilize technologies such as fine time measurement (FTM), Ultra-Wide band (UWB), or HADM, and transmit the one or more phase difference values to the network device by utilizing Wi-Fi, Bluetooth Low Energy (BLE), or the like, or via a wired network.

In still more embodiments, the network device may be configured to receive, from the at least one peer network device, the one or more phase difference values between the transmitted tone sequence received by the at least one peer network device and the reflected tone sequence the at least one peer network device received from the excited BKD. In further additional embodiments, the network device may be configured to determine a location of the BKD based on the received one or more phase difference values.

Thus, the devices and methods facilitating localization of BKDs may offer several advantages, including but not limited to, improved asset tracking, efficient inventory management, and enhanced security through precise monitoring of tagged items or devices. In logistics and supply chains, localization of BKDs may enable real-time tracking of goods, reducing losses, and streamlining operations. For IoT applications, accurate localization of BKDs may allow better environmental monitoring by pinpointing sensor positions without needing active transmissions or batteries. Additionally, in toll systems or access control, precise BKD tracking may ensure smoother, automated processes with minimal delays. Overall, precise BKD tracking may enhance operational efficiency, security, and energy savings across various industries.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

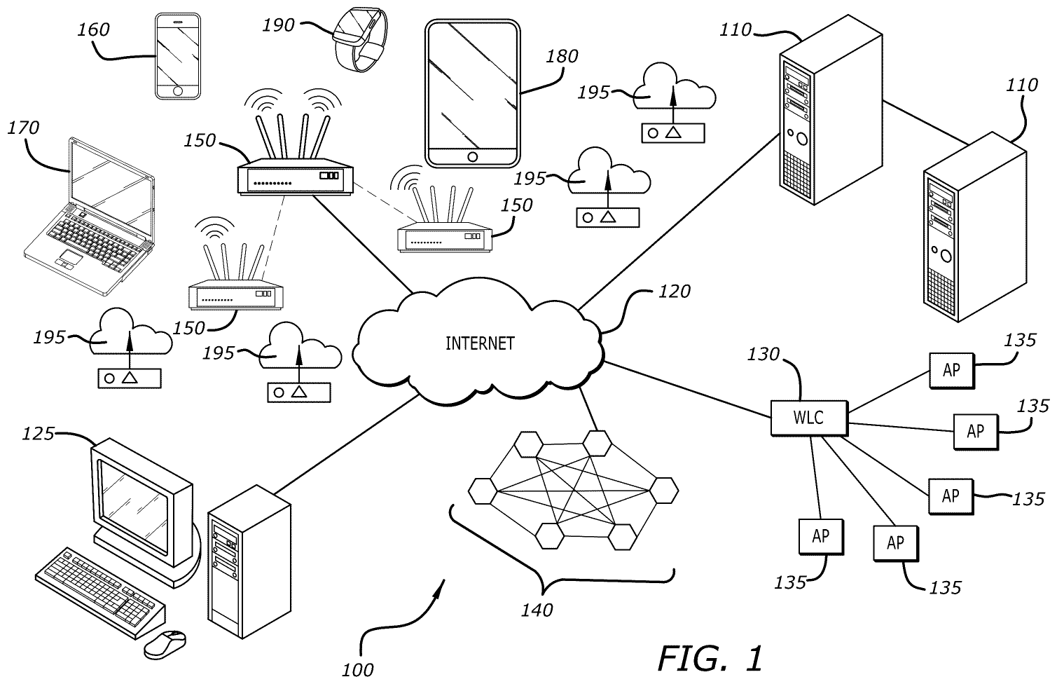

Referring to FIG. 1, a conceptual network diagram of various environments that implement a location detection logic in accordance with various embodiments of the disclosure is shown. The location detection logic can include various hardware and/or software deployments and can be configured in a variety of ways. In some non-limiting examples, the location detection logic can be configured as a standalone device, exist as a logic within another network device, be distributed among various network devices operating in tandem, or remotely operated as part of a cloud-based network management tool. The embodiments shown in FIG. 1 illustrate a network 100 comprising a plurality of network devices that can implement the location detection logic for localization of ambient (AMP) backscatter devices (BKDs).

In many embodiments, the network 100 may include cloud-based centralized management servers 110 connected to a communication network 120 (shown as the Internet). The communication network 120 can include wired networks or wireless networks. The centralized management servers 110 can be configured to execute the location detection logic. In a variety of embodiments, the network 100 may further include remote networks, such as, but not limited to a deployed network 140.

In a number of embodiments, the network 100 may include a plurality of network access points (APs) 150. The APs 150 may facilitate Wi-Fi connections for various electronic devices, such as but not limited to, mobile computing devices including laptop computers 170, cellular phones 160, portable tablet computers 180, wearable computing devices 190, and BKDs 195. The BKDs 195 may refer to those network devices that can harness ambient energy sources (for example, solar, thermal, or Radio Frequency “RF” energy) to power their operations, thereby reducing reliance on traditional power supplies and enhancing sustainability. The BKDs 195 may include, for example, solar-powered Internet-of-Things (IoT) devices, thermal energy harvesting sensors, RF energy harvesting devices, piezoelectric energy harvesting units, ambient light-powered indoor sensors, small-scale wind energy harvesting devices, or the like. The APs 150 can be configured to execute the location detection logic. However, in further embodiments, the location detection logic may be operated as distributed logic across multiple APs 150. In the embodiment depicted in FIG. 1, the plurality of APs 150 can operate as the location detection logic in a distributed manner or may have one specific AP to implement the location detection logic for the various APs.

In more embodiments, the network 100 may include a wireless Local Area Network (LAN) controller (WLC) 130 configured to monitor or control power consumption of APs 135 connected to the WLC 130, either wired or wirelessly. The WLC 130 and/or the APs 135 can be configured to execute the location detection logic. In still more embodiments, a personal computer 125 may be utilized to access and/or manage various aspects of the network 100, either remotely or within the network 100 itself. In the embodiment depicted in FIG. 1, the personal computer 125 may communicate over the communication network 120 and can access the servers 110, the APs 150, or the WLC 130. In various embodiments, the APs 135, 150 and/or the WLC 130 may execute the location detection logic to locate and track the BKDs 195.

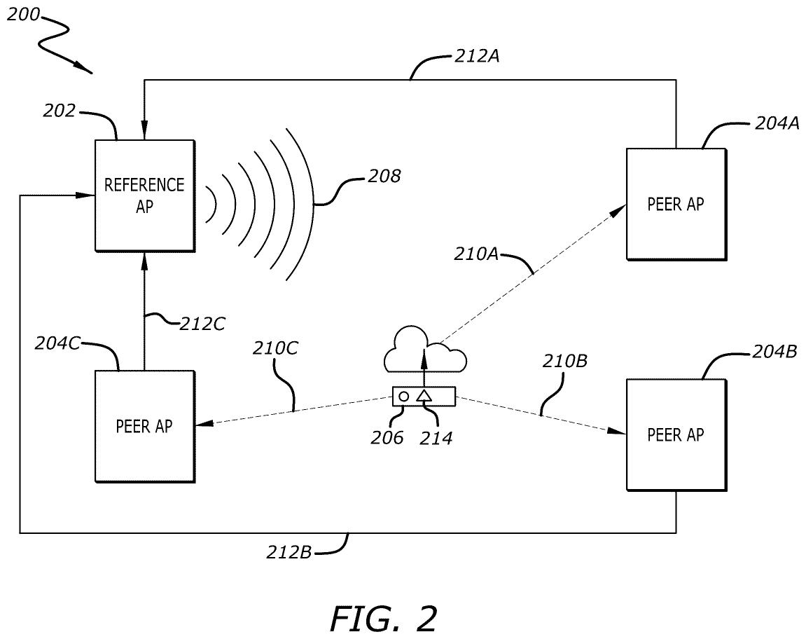

Although a specific embodiment for a conceptual network diagram of various environments that implement a location detection logic suitable for carrying out the various steps, processes, methods, and operations described herein is discussed with respect to FIG. 1, any of a variety of systems and/or processes may be utilized in accordance with embodiments of the disclosure. For example, the location detection logic may be provided as a device or software separate from the AP 150. The elements depicted in FIG. 1 may also be interchangeable with other elements of FIGS. 2-10 as required to realize a particularly desired embodiment.

Referring to FIG. 2, a schematic block diagram of an example communication network 200 implementing localization of a BKD in accordance with various embodiments of the disclosure is shown. The communication network 200 may refer to a high-speed, high-bandwidth interconnect system that enables multiple network devices to communicate with each other efficiently and reliably.

In many embodiments, the communication network 200 may include a reference AP 202 (e.g., a network device) and a set of peer APs 204A-204C that facilitate localization of one or more AMP BKDs, for example, a BKD 206. The reference AP 202 may be a network device configured with a location detection logic that enables localization and tracking of the BKD 206. The reference AP 202 may act as a source of RF energy and can utilize one or more beamforming techniques to focus signal strength in a specific direction to enable localization of the BKD 206.

For the sake of brevity and in a non-limiting example, the communication network 200 is shown in FIG. 2 to include only one reference AP 202 and three peer APs 204A, 204B, 204C for location determination of the BKD 206. However, in an actual implementation, the communication network 200 can include any number of reference APs and peer APs spread across different geographical regions for localization of any number of BKDs in the corresponding regions.

In one or more embodiments, the reference AP 202 may include a network controller configured to provide access to a wireless network and to communicatively couple to the set of peer APs 204A-204C. The reference AP 202 may also include a processor and a memory communicatively coupled to the processor. The memory may include the location detection logic or the location detection logic can be embodied as a standalone component, for example, a dedicated location detection device, within the reference AP 202. Alternatively, the location detection logic may be implemented external to the reference AP 202. The reference AP 202 may be configured to implement the location determination of the BKD 206 by way of the location detection logic.

In a variety of embodiments, the reference AP 202 may transmit an announcement frame to announce an intent of the reference AP 202 to perform a location determination event for the BKD 206 at a target time. The announcement frame may serve as an advance notice to the set of peer APs 204A-204C to be ready for participating in the location determination event at the target time. The announcement frame may be an action frame referred to as Action for Multi-Point Localization Announcement (AMPLA). In more embodiments, at least one peer AP (e.g., AP 204A or AP 204B or AP 204C) of the set of peer APs 204A-204C may be designated by the reference AP 202 to participate in the location determination event. In other embodiments, at least two peer APs (peer APs 204A-204B, peer APs 204A-204C, or peer APs 204B-204C) may be designated by the reference AP 202 to participate in the location determination event, while in several other embodiments, all the peer APs 204A, 204B, 204C in the communication network 200 may be designated by the reference AP 202 to participate in the location determination event. In a non-limiting example, it is assumed that the set of peer APs 204A-204C is designated by the reference AP 202 to participate in the location determination event. Thus, the reference AP 202 may transmit the announcement frame to a known multicast address of the set of peer APs 204A-204C as an indication to the set of peer APs 204A-204C to participate in the location determination event for the BKD 206. Additionally or alternatively, the reference AP 202 may broadcast the announcement frame. Based on the location detection logic, the reference AP 202 can transmit announcement frames periodically to locate the BKD 206 or other BKDs. In more embodiments, the set of peer APs 204A-204C may receive the announcement frame from the reference AP 202 and respond with an acknowledgment, confirming its participation in the location determination event.

In many more embodiments, the announcement frame may communicate information about the location determination event to the set of peer APs 204A-204C, enabling the set of peer APs 204A-204C to synchronize their operations for accurate localization of the BKD 206. The information communicated in the announcement frame may include the target time, a target channel, a target duration, identifiers of the set of peer APs 204A-204C, an identifier of the BKD 206, information corresponding to a tone sequence to be transmitted to excite the BKD 206 during the location determination event, or the like. An identifier may be a unique identification parameter assigned to a device for the purpose of identification and communication within the communication network 200. The identifier can take various forms, such as a Media Access Control (MAC) address, a serial number, or other proprietary identification numbers. In an example, a device identifier can be a MAC address. The MAC address may include six groups of two hexadecimal digits. For example, 00:1A:2B:3C:4D:5E may be a MAC address where the first three groups (00:1A:2B) represent an Organizational Unique Identifier (OUI) assigned to a manufacturer/vendor, and the last three groups (3C:4D:5E) are unique to the device itself. In other examples, the identifier can be a serial number. A serial number may include an alphanumeric string assigned to a device by a manufacturer. For example, SN12345678 may be a serial number for a specific model of a device. Each of the set of peer APs 204A-204C and the BKD 206 may be associated with such identifiers.

In various embodiments, the identifiers of the set of peer APs 204A-204C may be included in the announcement frame to indicate which peer network device(s) are designated to participate in the location determination event. Further, the identifier of the BKD 206 may be included in the announcement frame to ensure that the correct BKD is targeted or tracked during the location determination event. Additionally, the target time may be included in the announcement frame to notify the set of peer APs 204A-204C regarding an execution time for the location determination event. Further, the target channel may be included in the announcement frame to indicate which frequency channel is intended to be utilized for the location determination event, and the target duration may be provided to define for how long the location determination event may last. The target duration may be set long enough to allow the set of peer APs 204A-204C to temporarily leave their corresponding active channels and switch to the target channel for participating in the location determination event. Further, the target duration may be set to allow the BKD 206 enough time to reflect the transmitted tone sequence and generate an appropriate signal for localization. Furthermore, the information corresponding to the tone sequence may include various parameters characterizing the tone sequence, for example, an order, a frequency, or a phase of a plurality of tones in the tone sequence, a frequency hopping pattern associated with the tone sequence, a duration of symbols in each tone of the tone sequence, or the like.

In various embodiments, the reference AP 202 may transmit a tone sequence 208 at the target time for the target duration on the target channel specified in the announcement frame. For example, the reference AP 202 may broadcast the tone sequence 208 at the target time for the target duration on the target channel, ensuring sufficient time for accurate localization. The tone sequence 208 may be transmitted to excite as well as locate the BKD 206. In other words, the tone sequence may serve a dual function of energizing the BKD 206 and locating the BKD 206. “Tone sequence” may include the plurality of tones, each with defined frequencies, phases, or durations, transmitted sequentially in an order. The plurality of tones may include non-data bearing tones and may be phase consistent. In other words, the plurality of tones may carry no actual data or payload, and may be consistent in phase with each other. In one or more embodiments, the tone sequence 208 may include serially decreasing or serially increasing frequencies with consistent phase. For example, the plurality of tones in the tone sequence 208 may exhibit a monotonic progression, either ascending from low to high or descending from high to low, consistent in phase. In many other embodiments, the tone sequence 208 may incorporate a frequency hopping pattern or a random pattern in the plurality of tones, while maintaining consistent phase among the plurality of tones. Thus, to transmit the tone sequence, the reference AP 202 may sequentially transmit the plurality of tones.

In several embodiments, at the specified target time, the set of peer APs 204A-204C may tune to the target channel specified in the announcement frame and begin listening for the tone sequence 208 from the reference AP 202. For example, if the peer AP 204A is already tuned to a different channel, the peer AP 204A may switch from the different channel to the target channel as the target time approaches. Tuning to the target channel may involve configuring one or more radios (e.g., monitor radios) to listen to the target channel. In many scenarios, an AP of the set of peer APs 204A-204C may transmit a null frame with a duration field set for the target period to quiet the target channel and minimize interference on the target channel, during the location determination event. In several more embodiments, upon tuning to the target channel, the set of peer APs 204A-204C may be configured to receive the tone sequence 208 transmitted by the reference AP 202 at the target time on the target channel.

In numerous embodiments, the BKD 206 may include an antenna 214 configured to receive the tone sequence 208 (e.g., the plurality of tones) at the target time. Hardware of the BKD 206 may react to RF energy received in the tone sequence 208, and create, based on impedance modulation of the antenna 214, an on/off keying pattern in synchronization with the phase of the plurality of tones. For example, to create a ‘1’ (or ‘on’), the BKD 206 may modulate the antenna impedance to match a load (e.g., the tone sequence 208), and to create a ‘0’ (or ‘off’), the BKD 206 may modulate the antenna impedance to create a mismatch with the load. Further, the BKD 206 may synchronize the modulation of the antenna impedance with the phase of the plurality of tones in the tone sequence 208. In the on/off keying pattern, ‘on’ may allow the BKD 206 to reflect RF energy and ‘off’ may cause the BKD 206 to absorb RF energy. In other words, the BKD 206 may reflect the tone sequence 208 based on the on/off keying pattern. Reflections of the tone sequence 208 are shown as reflected tone sequences 210A, 210B, 210C in FIG. 2.

In an example, the reflected tone sequence 210A may be directed towards the peer AP 204A, while the reflected tone sequence 210B may be directed towards the peer AP 204B. Likewise, the reflected tone sequence 210C may be directed towards the peer AP 204C. Since the set of peer APs 204A-204C is tuned to the target channel, the set of peer APs 204A-204C may receive corresponding reflected tone sequences 210A, 210B, 210C. For example, the peer AP 204A may receive the reflected tone sequence 210A, while the peer AP 204B may receive the reflected tone sequence 210B. Similarly, the peer AP 204C may receive the reflected tone sequence 210C.

After receiving both tone sequences (e.g., original and reflected), each peer AP may determine one or more phase difference values between the tone sequence 208 received the peer AP and the reflected tone sequence received the peer AP. For example, the peer AP 204A may determine one or more phase difference values between the tone sequence 208 received by the peer AP 204A and the reflected tone sequence 210A received by the peer AP 204A. Further, the peer AP 204B may determine one or more phase difference values between the tone sequence 208 received by the peer AP 204B and the reflected tone sequence 210B received by the peer AP 204B. Furthermore, the peer AP 204C may determine one or more phase difference values between the tone sequence 208 received by the peer AP 204C and the reflected tone sequence 210C received by the peer AP 204C. In an example, a phase difference value corresponding to a tone of the plurality of tones may indicate a slope of the phase differences between the received tone and the received reflected tone. The reflected tone sequences 210A-210C may differ in phase from the tone sequence 208 due to the time the reflected tone sequences 210A-210C take to travel from the BKD 206 to respective peer APs 204A-204C. The phase difference values may represent a phase offset between the transmitted tone sequence 208 and the reflected tone sequences 210A-210C. Further, as the tone sequence 208 includes multiple tones, each peer AP of the set of peer APs 204A-204C may determine multiple phase difference values. In further embodiments, the set of peer APs 204A-204C may transmit corresponding phase difference values to the reference AP 202. In yet various embodiments, the set of peer APs 204A-204C may transmit the phase difference values to the reference AP 202 in an action frame. For example, the peer AP 204A may transmit a first action frame 212A and the peer AP 204B may transmit a second action frame 212B to the reference AP 202. Further, the peer AP 204C may transmit a third action frame 212C to the reference AP 202.

In still more embodiments, the reference AP 202 may be configured to receive, from the set of peer APs 204A-204C, the first through third action frames 212A-212C, each indicating the phase difference values determined by the corresponding peer APs 204A-204C. In other words, the reference AP 202 may receive the phase difference values between the transmitted tone sequence 208 received by a corresponding peer AP and the reflected tone sequence the corresponding peer AP received from the excited BKD 206.

In further additional embodiments, the reference AP 202 may be configured to determine a location of the BKD 206 based on the received one or more phase difference values, for example, the first through third action frames 212A-212C. By utilizing the phase difference values, the reference AP 202 may employ techniques such as phase-based triangulation or interferometry to pinpoint the location of the BKD 206. In many additional embodiments, the reference AP 202 may have knowledge regarding locations of the set of peer APs 204A-204C. Thus, upon receiving the one or more phase difference values from each of the set of peer APs 204A-204C, the reference AP 202 may determine a distance of the BKD 206 from each of the set of peer APs 204A-204C. For example, the reference AP 202 may utilize the correlation between phase difference, frequency, and distance to determine the distance of the BKD 206 from each of the set of peer APs 204A-204C. Further, based on the known locations of the set of peer APs 204A-204C and the determined distances of the BKD 206 to each of the set of peer APs 204A-204C, the reference AP 202 may determine the location of the BKD 206. Thus, by aggregating the phase difference values from the set of peer APs 204A-204C, the reference AP 202 may determine the location of the BKD 206 more accurately.

Although a specific embodiment for an example communication network 200 suitable for carrying out the various steps, processes, methods, and operations described herein is discussed with respect to FIG. 2, any of a variety of systems and/or processes may be utilized in accordance with embodiments of the disclosure. For example, in still numerous embodiments, an additional set of location anchors may be placed more densely along with the set of APs 204A-204C relative to the reference AP 202 to enhance the accuracy of the location of the BKD 206, especially when there may be multiple BKDs in the vicinity. In still yet more embodiments, the additional set of location anchors may also receive the tone sequence 208 from the reference AP 202 and the reflected tone sequence from the BKD 206. The additional set of location anchors may further transmit one or more phase difference values to the reference AP 202. In many additional embodiments, the additional set of location anchors may utilize technologies such as FTM, UWB, or HADM, and transmit the one or more phase difference values to the reference AP 202 by utilizing, for example, Wi-Fi, BLE, or a wired communication. Though FIG. 2 is described with respect to the reference AP 202 executing the location detection logic for locating the BKD 206, the scope of disclosure is not limited to it. In various additional embodiments, a WLC, a dedicated location server, or the like can execute the location detection logic for locating the BKD 206. The elements depicted in FIG. 2 may also be interchangeable with other elements of FIG. 1 and FIGS. 3-10 as required to realize a particularly desired embodiment.

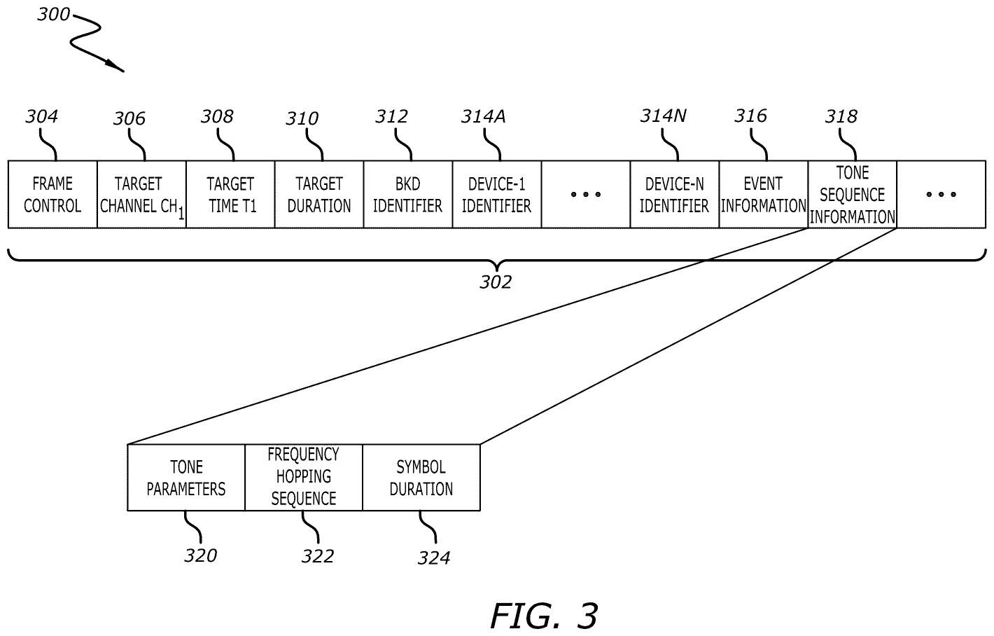

Referring to FIG. 3, a block diagram 300 that illustrates a format of an example announcement frame in accordance with various embodiments of the disclosure is shown. In one or more embodiments, a network device (for example, a reference AP, a primary AP, main AP, a WLC, a location server, or the like) can execute a location determination event for at least one BKD. The network device may collaborate with at least one peer network device of a set of peer network devices in a communication network to execute the location determination event.

In a variety of embodiments, the network device may transmit an announcement frame 302 to announce an intent of the network device to execute the location determination event for the BKD at a target time. The announcement frame 302 may function as an advance notice to the set of peer network devices to be ready for participating in the location determination event at the target time. In many more embodiments, the announcement frame 302 may be an action frame referred to as AMPLA. The announcement frame 302 may be transmitted to a known multicast address of the set of peer network devices. Additionally or alternatively, the announcement frame 302 can be broadcasted to the set of peer network devices. In many more embodiments, the announcement frame 302 may communicate information about the location determination event to the set of peer network devices.

In many embodiments, the announcement frame 302 may include a plurality of information elements (IEs). For example, the plurality of IEs can be frame control 304, target channel “CH₁” 306, target time “T₁” 308, target duration 310, BKD identifier 312, device identifiers 314A-314N (labeled as “Device-1 identifier,” . . . “Device-N identifier”), event information 316, tone sequence information 318, or the like. The tone sequence information 318 may further include one or more sub-fields such as tone parameters 320, frequency hopping sequence 322, symbol durations 324, or the like.

In a non-limiting example, the frame control 304 may include information for identifying the announcement frame 302 as an action frame and define how the announcement frame 302 may be processed by receiving devices (e.g., the set of peer network devices). The target channel “CH₁” 306 may include details of a target channel intended to be utilized for the location determination event. The target channel may refer to a spectrum of frequencies with a specific bandwidth on which the network device may transmit a tone sequence during the location determination event for locating the BKD. The target channel may be an active channel shared by the network device and the set of peer network devices to minimize interference.

Further, the target time “T₁” 308 may include details of a time instance (e.g., a timestamp) for initiating the tone sequence transmission and executing the location determination event. The target time may enable all APs perform their tasks in synchronization. Additionally, the target duration 310 may define a time duration of the location determination event, for example, for how long the tone sequence or signal is intended to remain active. The target duration 310 may be set to provide the set of peer network devices sufficient time to temporarily switch from their used channel to the target channel, and also provide enough time for the BKD to reflect the tone sequence and generate a clear, detectable reflected tone sequence.

In another example scenario, the BKD identifier 312 may include a unique identifier of a target BKD that is to be located by way of the location determination event. The BKD identifier 312 may enable the set of peer network devices to recognize the BKD. Further, the device identifiers 314A-314N may include unique identification details of peer network devices of the set of peer network devices that are designated to participate in the location determination event in collaboration with the network device.

The event information 316 may include one or more details regarding a Basic Service Set Identifier (BSSID) to identify the network or wireless service set associated with the network device, enabling the set of peer network devices to associate the announcement frame 302 with the correct network. The event information may further include an action category and an action code to indicate that the announcement frame 302 may be related to location services. The action code may specify the type of action (e.g., announcing a location determination event, request for participation, or the like).

Furthermore, the tone sequence information 318 may include information about the tone order, a frequency, a phase, a frequency hopping pattern, or a duration of symbols within each tone of the tone sequence. In some scenarios, the tone parameters 320 may include key attributes that define how a plurality of tones of the tone sequence may be structured and transmitted. For example, the tone sequence information 318 may indicate that the phase of the plurality of tones is consistent whereas the frequency of each tone is different from remaining tones of the tone sequence. The frequency hopping sequence 322 may indicate frequency hopping pattern from one tone to another in the tone sequence. The symbol durations 324 may include details regarding a duration of each tone, for example, for how long each tone is transmitted.

Although a specific embodiment for a format of an announcement frame suitable for carrying out the various steps, processes, methods, and operations described herein is discussed with respect to FIG. 3, any of a variety of systems and/or processes may be utilized in accordance with embodiments of the disclosure. For example, the announcement frame can also include various other fields or IEs such as checksum, cyclic redundancy check, identifiers of an additional set of anchors that are designated to participate in the location detection event, or the like. The elements depicted in FIG. 3 may also be interchangeable with other elements of FIGS. 1, 2, and 4-10 as required to realize a particularly desired embodiment.

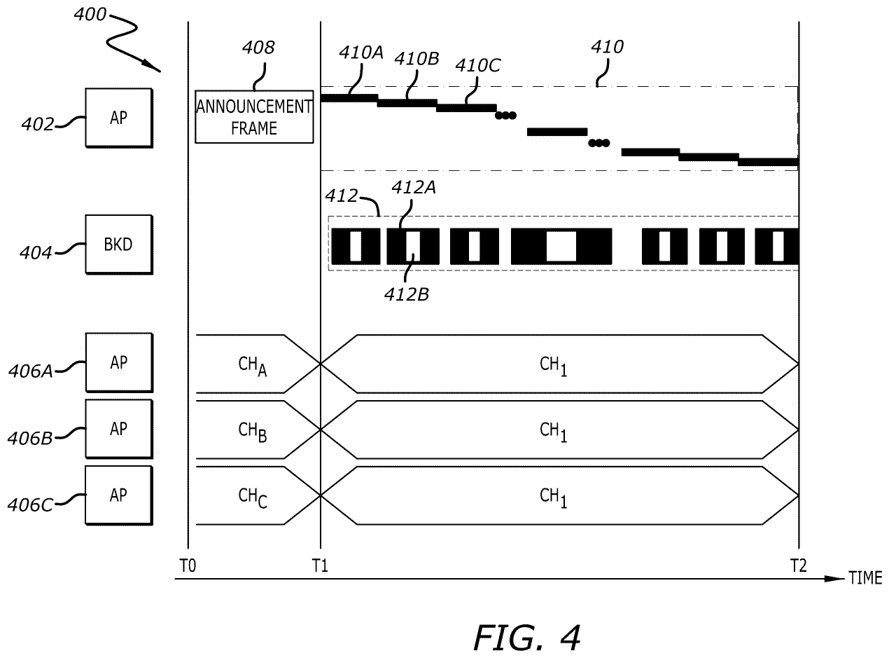

Referring to FIG. 4, a schematic flow diagram 400 that illustrates a location determination event of a BKD in accordance with various embodiments of the disclosure is shown. Embodiments shown in FIG. 4 may illustrate an example location determination event executed by a reference network device (e.g., a first AP 402) to determine a location of a BKD 404. The first AP 402 may designate at least one peer network device (e.g., second through fourth APs 406A, 406B, 406C) to participate in the location determination event.

In various embodiments, the first AP 402 may be configured with a transmitter that can transmit a series of RF signals based on requirement. The first AP 402 may further include a receiver that can receive one or more signals from one or more peer network devices. In many embodiments, the BKD 404 may be a passive ambient BKD that can transmit data utilizing RF signals without requiring a battery or a power grid connection. The BKD 404 may include an antenna to receive an RF signal and convert the received RF signal into electric power. The BKD 404 may utilize the electric power to modify and reflect the RF signal. Antennas on other devices (e.g., the second through fourth peer APs 406A-406C), in turn, may receive the reflected RF signal and can respond accordingly.

In an example scenario shown in FIG. 4, the first AP 402 may transmit an announcement frame 408 during a time duration T₀-T₁ to notify the second through fourth peer APs 406A-406C about an upcoming location determination event. The announcement frame 408 may include information such as a target channel “CH₁”, a target time “T₁”, a target duration “T-T₂”, an identifier of the BKD 404, identifiers of the second through fourth peer APs 406A-406C, event information, tone sequence information, or the like.

In a variety of embodiments, as the target time “T₁” approaches, the first AP 402 may generate a tone sequence 410 including a plurality of tones 410A-410N. As shown through an example in FIG. 4, the plurality of tones 410A-410N exhibits a monotonic progression, descending from high to low with consistent phase. In other examples, the tone sequence 410 can include a plurality of tones that exhibits a monotonic progression ascending from low to high, a frequency hopping pattern, while maintaining consistent phase among the plurality of tones 410A-410N. Further, the frequencies of the tone sequence 410 may be in a range that the BKD 404 can detect and reflect the tone sequence 410. Hence, the tone sequence 410 can be different for locating different BKDs based on BKD hardware.

In more embodiments, the first AP 402 may transmit the generated tone sequence 410 at the target time T₁ on the target channel CH₁ for the target duration T₁-T₂. The tone sequence 410 may be received by the antenna of the BKD 404. The BKD 404 may create, based on impedance modulation of the antenna, an on/off keying pattern (in FIG. 4, shaded portion 412A indicates “on” pattern and unshaded portion 412B indicates “off” pattern) in synchronization with the phase of the plurality of tones 410A-410N for the target duration T₁-T₂. The BKD 404 may reflect the tone sequence 410 based on the on/off keying pattern to generate. A reflected tone sequence 412 may be transmitted by the antenna of the BKD 404 to the second through fourth peer APs 406A-406C.

During the time duration T₀-T₁, the second through fourth peer APs 406A-406C may be operating on one or more active channels (e.g., CH_{A}, CH_{B}, and CH_{C}). In the example shown in FIG. 4, the second AP 406A is operating on a channel CH_{A}, the third AP 406B is operating on a channel CH_{B}, and the fourth AP 406C is operating on a channel CH_{C}. During the same time, e.g., between T₀-T₁, the second through fourth peer APs 406A-406C may receive the announcement frame 408. Upon receiving the announcement frame 408, the second through fourth peer APs 406A-406C record the target time T₁, the target channel CH₁, and the target duration T₁-T₂ specified in the announcement frame 408.

In yet more embodiments, at least one AP of the second through fourth peer APs 406A-406C may decide to participate in the location determination event. In still yet more embodiments, all the three peer APs 406A-406C may decide to participate in the location determination event. In the example embodiment depicted in FIG. 4, the second through fourth peer APs 406A-406C are shown to participate in the location determination event.

Thus, at time T₁, the second through fourth peer APs 406A-406C may switch (e.g., tune) to the target channel CH₁ from their respective channels CH_{A}, CH_{B}, CH_{C} to listen to the tone sequence 410. The second through fourth peer APs 406A-406C may receive the tone sequence 410 during the target duration T₁-T₂ on the target channel CH₁. After receiving the tone sequence 410, the second through fourth peer APs 406A-406C may now listen for the reflected tone sequence 412 from the BKD 404. The second through fourth peer APs 406A-406C may receive the reflected tone sequence 412 during the target duration T₁-T₂, and analyze the tone sequence 410 and the reflected tone sequence 412 to determine one or more phase difference values between the two received signals. The second through fourth peer APs 406A-406C may then transmit the one or more phase difference values to the first AP 402 in an action frame or a similar message format. In further embodiments, the one or more phase difference values may be received by the first AP 402 and utilized to determine the location of the BKD 404.

Although a specific embodiment for the location determination event of the BKD suitable for carrying out the various steps, processes, methods, and operations described herein is discussed with respect to FIG. 4, any of a variety of systems and/or processes may be utilized in accordance with embodiments of the disclosure. For example, the plurality of tones 410A-410N can be arranged in any random pattern, where frequencies of adjacent tones in the tone sequence 410 are different. The elements depicted in FIG. 4 may also be interchangeable with other elements of FIGS. 1-3 and 5-10 as required to realize a particularly desired embodiment.

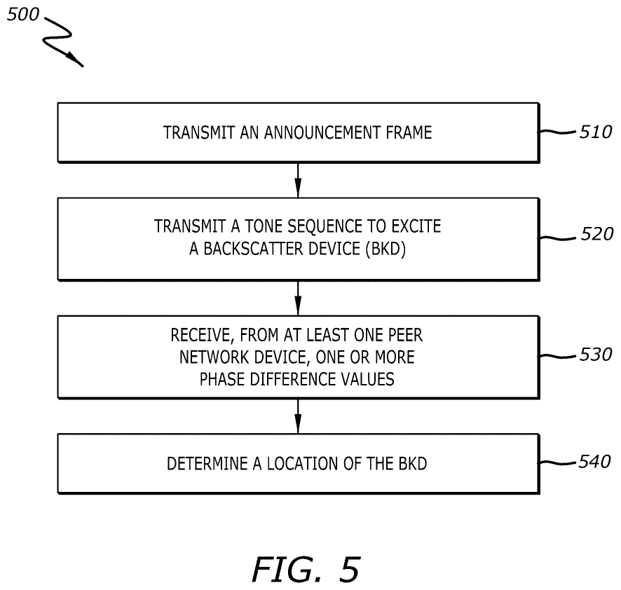

Referring to FIG. 5, a flowchart depicting a process 500 for localization of a BKD in accordance with various embodiments of the disclosure is shown. The process 500 may be performed at a network device (e.g., a reference AP, a primary AP, a WLC, a location server, or the like). The network device may include a network controller configured to provide access to a network and communicatively coupled to a set of peer network devices (e.g., peer APs, location anchors, other wireless enabled devices, or the like). In many embodiments, the process 500 may transmit an announcement frame (block 510). The process 500 may transmit the announcement frame to notify the set of peer network devices about an upcoming location determination event to locate and track a passive BKD. The announcement frame may include information related to frame control, a target channel, a target time, a target duration, an identifier of the BKD, identifiers of the set of peer network devices, event information, tone sequence information, or the like. For example, the frame control information may be utilized to identify the frame as an action frame and define how the announcement frame can be processed by the set of peer network devices. The target channel may indicate an active channel intended to be utilized for the location determination event. Further, the target time may indicate a start time of the location determination event, and the target duration may define a total duration of the location determination event. Furthermore, the identifiers of the set of peer network devices may be indicative of which peer network devices are designated to participate in the location determination event. The identifier of the BKD may be included in the announcement frame so that the correct device is targeted during the location determination event. The announcement frame may also include information corresponding to the tone sequence to be transmitted by the network device during the location determination event. Furthermore, the information corresponding to the tone sequence may indicate, for example, an order, a frequency, a phase of the tones, a frequency hopping pattern associated with the tone sequence, a duration of symbols in each tone of the tone sequence, or the like. The process 500 can broadcast the announcement frame or transmit to a known multicast address.

In various embodiments, the process 500 may transmit the tone sequence to excite the BKD (block 520). In one or more embodiments, the process 500 may generate the tone sequence configured to energize the BKD. The tone sequence may include a plurality of tones with specific frequencies or durations in a defined order. The plurality of tones may be phase consistent with each other. In one or more embodiments, the plurality of tones may be non-data bearing tones. In numerous embodiments, the process 500 may transmit the tone sequence at the target time on the target channel for the target duration. In several embodiments, the tone sequence may be received by at least one peer network device and the BKD. The BKD may further reflect the tone sequence, which is received by the at least one peer network device.

In a variety of embodiments, the process 500 may receive, from the at least one peer network device one or more phase difference values (block 530). For example, the one or more phase difference values may be between the transmitted tone sequence received by the at least one peer network device and the reflected tone sequence the at least one peer network device received from the excited BKD. In other words, the one or more phase difference values may correspond to phase offsets between the transmitted tone sequence received by the at least one peer network device and the reflected tone sequence the at least one peer AP received from the BKD. The one or more phase difference values may provide insight into paths followed by the tone sequence and the reflected tone sequence, and enable accurate detection of location of the BKD. In many further embodiments, the process 500 may receive the one or more phase difference values in an action frame or a similar message format.

In a number of embodiments, the process 500 may determine a location of the BKD (block 540). The process 500 may analyze the one or more phase difference values received from the at least one peer AP to determine the location of the BKD. By analyzing the one or more phase difference values, the process 500 may estimate the distance between the at least one peer AP and the BKD, accounting for signal delays, multi-path reflections, and phase shifts. Phase difference values received from multiple peer network devices may be utilized for determining the location of the BKD.

Although a specific embodiment for localization of a BKD suitable for carrying out the various steps, processes, methods, and operations described herein is discussed with respect to FIG. 5, any of a variety of systems and/or processes may be utilized in accordance with embodiments of the disclosure. For example, the process 500 may receive a location update request for locating the BKD from a location service server. Examples of location service servers may include services that may provide real-time device tracking and geofencing, cloud-based platforms that may offer indoor location analytics and asset tracking by utilizing Wi-Fi access points, or the like. The elements depicted in FIG. 5 may also be interchangeable with other elements of FIGS. 1-4 and 6-10 as required to realize a particularly desired embodiment.

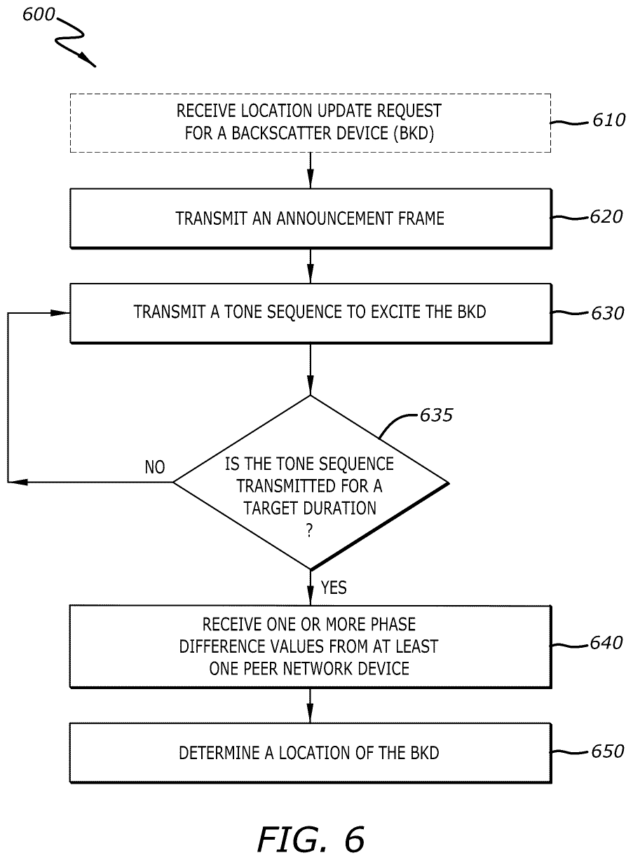

Referring to FIG. 6, a flowchart depicting a process 600 for executing a location determination event in accordance with various embodiments of the disclosure is shown. The process 600 may be performed at a network device that can run an associated software stack for the location determination event in a communication network. Examples of the network device can include a location detection logic, a location detection server, a controller, or the like. The network device may be communicatively coupled to a set of peer network device that participate in the location determination event for determining a location of a BKD.

In many embodiments, the process 600 may receive a location update request for the BKD (block 610). The process 600 may receive the location update request from a location service server for locating the BKD and may include one or more key parameters. In a non-limiting example, the location update request may indicate a location request identifier “ID” (e.g., “12345ABC”) and a timestamp to track the location update request, along with a BKD ID (e.g., “BKD_AAA_XYZ”) that is to be located. In various embodiments, the location update request may also identify the network device and the set of peer network devices that can collaborate for the location determination event.

In a variety of embodiments, the process 600 may transmit an announcement frame (block 620). Based on receiving the location update request, in one or more embodiments, the process 600 may transmit the announcement frame to announce an intent of the network device to execute the location determination event for locating the BKD. In many more embodiments, the announcement frame may communicate information about the upcoming location determination event to the set of peer network devices. In several embodiments, the process 600 may broadcast the announcement frame. In several additional embodiments, the process 600 may transmit the announcement frame to a known multicast address of the set of peer network devices.

In a number of embodiments, the process 600 may transmit a tone sequence to excite the BKD (block 630). The process 600 may transmit the tone sequence at the target time specified in the announcement frame on the target channel for the target duration. In one or more embodiments, the tone sequence may include a plurality of tones that may be transmitted sequentially in a defined order. Each tone of the plurality of tones may be consistent in phase with other tones of the plurality of tones. The tone sequence may excite the BKD and the BKD may reflect the tone sequence by way of an on/off keying pattern. The tone sequence may be further received by at least one peer network device of the set of peer network devices.

In more embodiments, the process 600 may determine whether the tone sequence is transmitted for the target duration (block 635). In other words, the process 600 may determine if the target duration has expired or not. If the tone sequence is sent for a duration that is less than the target duration, the BKD may not be able to generate the complete reflected tone sequence. Thus, the process 600 may remain in loop until the tone sequence is transmitted for the specified target duration (block 635).

In still more embodiments, if the tone sequence is transmitted for the target duration, the process 600 may receive one or more phase difference values from one or more peer network devices (block 640). Each of the one or more peer network devices may determine corresponding one or more phase difference values. The one or more phase difference values are determined between the tone sequence received at a corresponding peer network device from the network device and the reflected tone sequence the peer network device received from the BKD. The one or more phase difference values may provide information about the paths and time taken by the tone sequence transmitted by the reference AP and the reflected tone sequence transmitted by the BKD.

In yet more embodiments, the process 600 may determine a location of the BKD (block 650). The process 600 may utilize the one or more phase difference values received from the one or more peer network devices to form one or more equations, the solution of which may pinpoint the location of the BKD. The process 600 may utilize triangulation methods, solutions to non-linear equations, or the like to determine the location of the BKD.

Although a specific embodiment for executing a location determination event suitable for carrying out the various steps, processes, methods, and operations described herein is discussed with respect to FIG. 6, any of a variety of systems and/or processes may be utilized in accordance with embodiments of the disclosure. For example, the location determination event of the BKD may be executed by a location detection logic at the at least one peer network device of the set of peer network devices. While the network device may transmit the tone sequence to excite the BKD, all other operations for locating the BKD may happen at the location detection logic at the at least one peer network device. Further, the location detection logic at the least one peer network device may determine a measurement data that may include one or more of: one or more time delay values, time offset values, slope offset values, or frequency offset values between the tone sequence transmitted by the network device and the reflected tone sequence from the BKD and received at the at least one peer network device. The measurement data may be then utilized by the location detection logic at the at least one peer network device itself to determine the location of the BKD. The elements depicted in FIG. 6 may also be interchangeable with other elements of FIGS. 1-5 and 7-10 as required to realize a particularly desired embodiment.

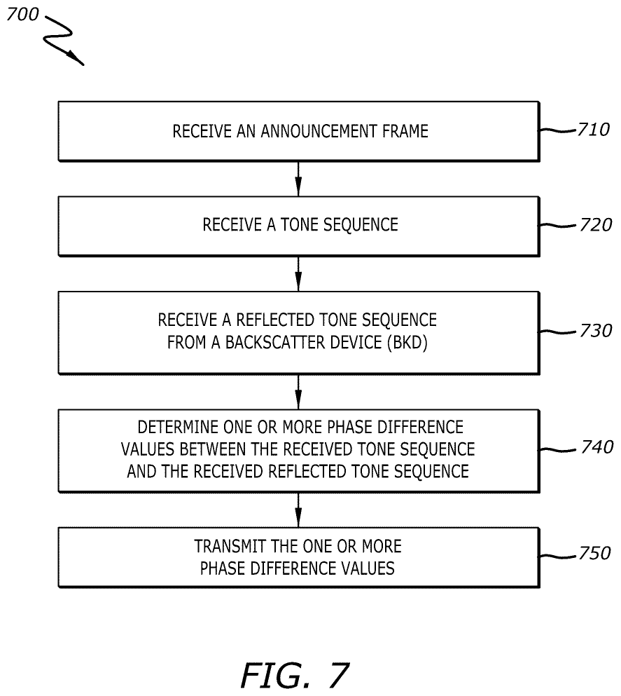

Referring to FIG. 7, a flowchart depicting a process 700 for determining measurement data during a location determination event of a BKD in accordance with various embodiments of the disclosure is shown. The process 700 may be performed at a peer network device (e.g. a peer AP, or a location anchor) communicatively coupled with a network device (e.g., a reference AP, a WLC, a location server, or the like) to collaborate for locating a BKD. In many embodiments, the process 700 may receive an announcement frame (block 710). The announcement frame may be received from the network device. The announcement frame may include information about an upcoming location determination event for the BKD. In various embodiments, the announcement frame may indicate parameters such as a frame control, a target time, a target channel, a target duration, an identifier of the BKD, identifiers of a set of peer network devices, event information, tone sequence information, or the like.

In a variety of embodiments, the process 700 may receive a tone sequence (block 720). At the target time specified in the announcement frame, the process 700 may listen on the specified target channel and receive the tone sequence from the network device. The tone sequence may include a series of RF tones with defined frequencies, phases, or durations, designed to energize the BKD. Each tone of the series of RF tones (or a plurality of tones) in the tone sequence may be non-data bearing and phase consistent with other tones of the tone sequence.

In a number of embodiments, the process 700 may receive a reflected tone sequence from the BKD (block 730). In other words, after the tone sequence excites the BKD, the process 700 may receive the tone sequence reflected by the BKD. The process 700 may receive the reflected tone sequence on the designated target channel during the target duration.

In a variety of embodiments, the process 700 may determine one or more phase difference values between the received tone sequence and the received reflected tone sequence (block 740). For example, the process 700 may compare phases of the plurality of tones in the received tone sequence with phases of a plurality of reflected tones in the reflected tone sequence, and determine a phase offset value for each tone. The one or more phase difference values may be determined by analyzing the shift in phase between corresponding tones in the original and reflected tone sequences.

In numerous embodiments, the process 700 may transmit the one or more phase difference values (block 750). The process 700 may include the one or more phase difference values, as measurement data, in an action frame and transmit this measurement data to the network device. The measurement data may be utilized by the network device to determine the precise location of the BKD.

Although a specific embodiment for determining measurement data suitable for carrying out the various steps, processes, methods, and operations described herein is discussed with respect to FIG. 7, any of a variety of systems and/or processes may be utilized in accordance with embodiments of the disclosure. For example, the process 700 may tune a monitor radio of the peer network device to the target channel frequency as the target time approaches to listen the tone sequence. The elements depicted in FIG. 7 may also be interchangeable with other elements of FIGS. 1-6 and 8-10 as required to realize a particularly desired embodiment.

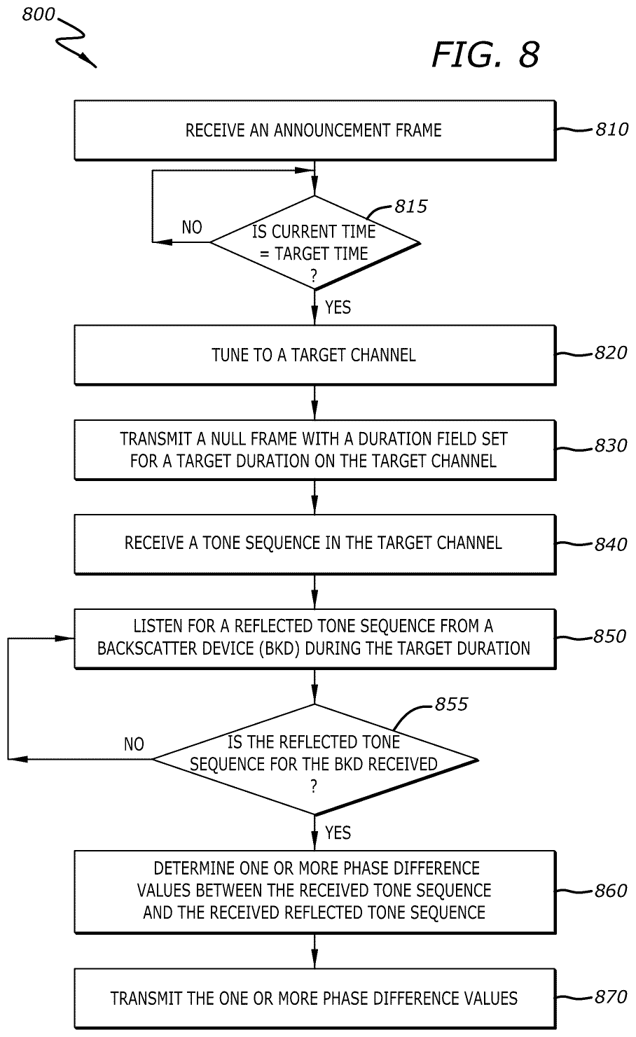

Referring to FIG. 8, a flowchart depicting a process 800 for determining measurement data during a location determination event of a BKD in accordance with various embodiments of the disclosure is shown. The process 800 may be performed at a peer network device that can run an associated software stack for a location determination. Examples of the peer network device can include a location controller, a location anchor, a peer AP, or the like. The peer network device may be communicatively coupled to a network device in a communication network.

In many embodiments, the process 800 may receive an announcement frame (block 810). The announcement frame may be received from the network device. The process 800, upon receiving the announcement frame, may extract and record the information specified in the announcement frame and prepare for participating in the location determination event. The process 800 may record a target time at which the location determination event is to occur. The process 800 may further record a target channel to be utilized in the location determination event. Furthermore, the process 800 may record a target duration for which the location determination event may last.

In a variety of embodiments, the process 800 may determine whether a current time is equal to the target time (block 815). The process 800 may monitor the current time so that at the target time the process 800 may perform one or more operations for the location determination event. In several embodiments, if the current time is not the target time, the process 800 may continue determining whether the current time is equal to the target time (block 815).

In a number of embodiments, if the current time is the target time, the process 800 may tune to the target channel (block 820). Accordingly, the process 800 may configure one or more radios (e.g., monitor radios) of the peer network device to listen to the target channel at the target time. For example, if the peer network device is tuned to a different channel, the process 800 may switch the peer network device from the different channel to the target channel as the target time approaches.

In more embodiments, the process 800 may transmit a null frame with a duration field set for the target duration on the target channel (block 830). The null frame may be a control frame transmitted to temporarily quiet the target channel during the location determination event. The null frame may include minimal or no payload data, and may include key information in specific fields such as the time duration field, which specifies the time duration the target channel is intended to remain reserved or silent for. The null frame may prevent other devices from transmitting on the target channel during the location determination event, minimizing interference on the target channel. The null frame may also carry identifiers such as a source address and a target address, ensuring only participating network devices recognize the quiet period.

In still more embodiments, the process 800 may receive a tone sequence in the target channel (block 840). After the null frame has been transmitted by the process 800, the process 800 may start listening for the tone sequence and may receive the tone sequence from the network device on the target channel. The tone sequence may include a plurality of tones that may be received sequentially in a defined order indicated by the announcement frame. The plurality of tones may be non-data bearing tones that are consistent in phase.

In yet more embodiments, the process 800 may listen for the reflected tone sequence from the BKD during the target duration (block 850). The tone sequence received by the process 800 may also be received by the BKD, which may get powered on and reflect the plurality of tones. The process 800 may listen for the reflected tone sequence such that the process 800 can start processing the reflected tone sequence upon receiving.

In additional embodiments, the process 800 may determine whether the reflected tone sequence from the BKD is received (block 855). The process 800 may determine whether the reflected tone sequence from the BKD is received during the target duration specified in the announcement frame. In various embodiments, the reflected tone sequence and the tone sequence may be separated by a delay due to a longer path the reflected tone sequence has to travel to reach the peer network device. If the reflected tone sequence is not received, in several embodiments, the process 800 may continue listening for the reflected tone sequence (block 850).

In several more embodiments, if the reflected tone sequence is received from the BKD, the process 800 may determine one or more phase difference values between the received tone sequence and the received reflected tone sequence (block 860). The process 800 may analyze the tone sequence received from the network device and the reflected tone sequence received from the BKD, and estimate one or more phase offsets between the tones of the two signals. The one or more phase difference values may include a slope of the phase differences between tones of the received tone sequence and the received reflected tone sequence.

In numerous embodiments, the process 800 may transmit the one or more phase difference values (block 870). Upon determining the one or more phase difference values, the process 800 may transmit this measurement data (e.g., the one or more phase difference values) to the network device. The measurement data may be utilized by the network device to form one or more equations. Solving the one or more equations may pinpoint a specific position, or specific co-ordinates of the BKD. The specific co-ordinates may include a latitude and longitude of the BKD, a distance of the BKD relative to the reference AP or the like.

Although a specific embodiment for determining measurement data during a location determination event of a BKD suitable for carrying out the various steps, processes, methods, and operations described herein is discussed with respect to FIG. 8, any of a variety of systems and/or processes may be utilized in accordance with embodiments of the disclosure. For example, the process 800 may simultaneously occur at multiple peer network devices for determining the one or more phase difference values. In numerous additional embodiments, a set of peer network devices may transmit the one or more phase difference values randomly or sequentially, one after the other based on a priority order provided to each peer network device. The elements depicted in FIG. 8 may also be interchangeable with other elements of FIGS. 1-7, 9, and 10 as required to realize a particularly desired embodiment.

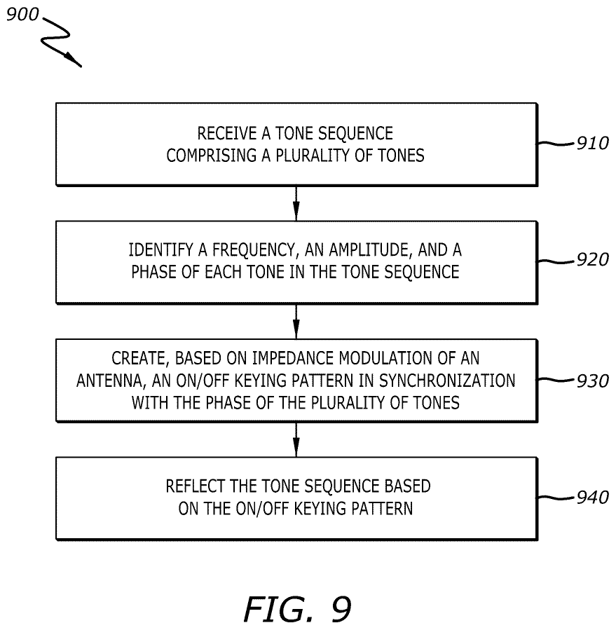

Referring to FIG. 9, a flowchart depicting a process 900 for reflecting a tone sequence by a BKD during a location determination event in accordance with various embodiments of the disclosure is shown. The BKD may be a passive BKD that can reflect RF signals instead of actively transmitting the RF signals. In many embodiments, the process 900 may receive a tone sequence comprising a plurality of tones (block 910). The tone sequence may be transmitted by a network device for locating the BKD. Each tone of the plurality of tones may be a non-data bearing tone and may be consistent in phase with other tones. The passive BKD may get powered on (e.g., excited) based on the received tone sequence.

In a variety of embodiments, the process 900 may identify a frequency, an amplitude, and a phase of each tone in the tone sequence (block 920). Identifying the frequency, the amplitude and the phase of each tone may enable the BKD to determine a phase relationship and align a modulation pattern of an antenna of the BKD with the received tone sequence. The process 900 may utilize the identified data to prepare for generating an on/off keying pattern.

In a variety of embodiments, the process 900 may create, based on an impedance modulation of the antenna, an on/off keying pattern in synchronization with the phase of the plurality of tones (block 930). In other words, the process 900 may switch between different impedance states (reflecting or non-reflecting) of the antenna. The switching may occur in synchronization with the phase of tones of the tone sequence. The on/off keying pattern may serve as a way for the BKD to reflect the tone sequence without actively transmitting. The process 900 may further ensure that the reflected tone sequence may contain phase-aligned information that can be detected by one or more peer network devices for localization.

In still additional embodiments, the process 900 may reflect the tone sequence based on the on/off keying pattern (block 940). The modulation pattern, aligned with the phase of the received tone sequence may reflect the received tone sequence. The original tone sequence and the reflected tone sequence may be utilized to determine the location of the BKD.

Although a specific embodiment for reflecting a tone sequence by a BKD suitable for carrying out the various steps, processes, methods, and operations described herein is discussed with respect to FIG. 9, any of a variety of systems and/or processes may be utilized in accordance with embodiments of the disclosure. For example, other than on/off keying pattern, the process 900 may generate frequency-shift keying (FSK) pattern for reflecting the tone sequence. The elements depicted in FIG. 9 may also be interchangeable with other elements of FIGS. 1-8 and 10 as required to realize a particularly desired embodiment.

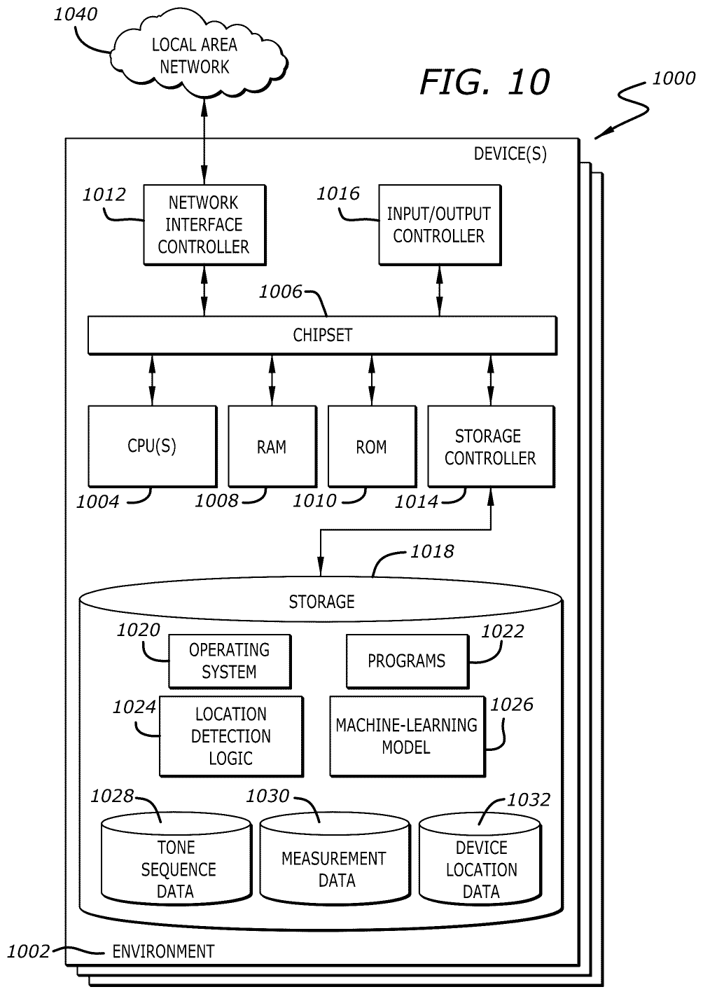

Referring to FIG. 10, a conceptual block diagram of a device 1000 suitable for configuration with a location detection logic in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many nonlimiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment by utilizing logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, programs 1022, tone sequence data 1028, measurement data 1030, and device location data 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer executable instructions may be stored as program 1022 (e.g., an application) and transform the device 1000 by specifying how the processor(s) 1004 can transition between states, as described above. In some embodiments, the device 1000 has access to computer-readable storage media storing computer executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many further embodiments, the device 1000 may include a location detection logic 1024. The location detection logic 1024 can be configured to perform one or more of the various steps, processes, operations, and/or other methods that are described above. Often, the location detection logic 1024 can be a set of instructions stored within a non-volatile memory that, when executed by the processor(s) 1004 can carry out these steps, etc. In numerous embodiments, the location detection logic 1024 may perform various operations related to localization of BKDs. In some embodiments, the device 1000 can be a reference network device. In such embodiments, the location detection logic 1024 may be configured to locate and track the BKDs. To enable this, the location detection logic 1024 may transmit an announcement frame to announce that the device 1000 may execute a location determination event for the BKDs at a target time. In many further embodiments, the location detection logic 1024 may transmit a tone sequence to excite the BKD at the target time indicated in the announcement frame. To transmit the tone sequence, the location detection logic 1024 may sequentially transmit a plurality of tones. For example, the plurality of tones may be sequentially transmitted as a monotonic progression, either ascending from low to high or descending from high to low, a frequency hopping pattern, or a random pattern. In many further embodiments, the location detection logic 1024 may be configured to receive, from at least one peer network device, one or more phase difference values between the transmitted tone sequence received by the at least one peer network device and a reflected tone sequence the at least one peer network device received from the excited BKD. In further additional embodiments, the location detection logic 1024 may be configured to determine a location of the BKD based on the received one or more phase difference values.

In more embodiments, the device 1000 may be a peer network device. In such embodiments, the location detection logic 1024 may be configured to receive the announcement frame and may respond with an acknowledgement to participate in the location determination event. Thus, at the target time indicated in the announcement frame, the location detection logic 1024 may tune the device 1000 to the target channel for listening to the tone sequence from the reference network device. In several more embodiments, the location detection logic 1024 may be configured to receive the tone sequence from the reference network device at the target time on the target channel. In many further embodiments, the location detection logic 1024 may also receive the reflected tone sequence from the BKD on the target channel. In still further embodiments, the location detection logic 1024 may determine the one or more phase difference values between the received tone sequence and the received reflected tone sequence, and transmit the one or more phase difference values to the reference network device.

In numerous embodiments, the device 1000 may include a BKD. The BKD may include an antenna to receive the tone sequence (e.g., the plurality of tones) at the target time. The location detection logic 1024 may create, based on impedance modulation of the antenna, an on/off keying pattern in synchronization with the phase of the plurality of tones for the target duration. The location detection logic 1024 may reflect the tone sequence based on the on/off keying pattern. The reflected tone sequence may be transmitted by the antenna to the at least one peer network device.

In various embodiments, the storage 1018 can include the tone sequence data 1028. The tone sequence data 1028 may refer to multiple non-data bearing tones, each with specific frequencies, phases, and amplitudes, transmitted in a defined pattern to excite a passive device such as a BKD. The tone sequence data 1028 may not carry traditional data but serve as reference signal for localization and identification. The tone sequence data 1028 may allow network devices to analyze phase shifts, time delays, or frequency variations between the transmitted and reflected signals for determining the precise location of BKDs, especially in environments with multipath interference.

In still more embodiments, the storage 1018 can include the measurement data 1030. The measurement data 1030 may refer to phase difference values between the transmitted tone sequence and the reflected tone sequence from a BKD, and may include parameters such as phase shifts, time delays, and signal strength variations. The phase difference values may indicate how the tone sequence changed during its interaction with the BKD and provide insights into the precise distance and relative position of the BKD. The measurement data 1030 may enable the device 1000 to calculate Time of Flight (ToF) and other metrics to estimate the location of the BKD accurately. In many further embodiments, the measurement data 1030 may be utilized to triangulate or multiliterate the exact coordinates of the BKD.

In a number of embodiments, the storage 1018 can include device location data 1032. The device location data 1032 may refer to information that describes the precise position of a device, such as a BKD, a set of peer network devices (e.g., neighboring APs) within a network or physical space. The device location data 1032 may include co-ordinates of the device, global positioning system (GPS) location of the device, addresses of the device or the like. The device location data 1032 for BKDs may be derived from measurements like phase difference values, angle of arrival (AoA) collected by access points (APs), or other peer devices.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the tone sequence data 1028, the measurement data 1030, and the device location data 1032, and utilize the learning to predict future outcomes. For example, the ML model(s) 1026 can be utilized for location of BKDs and its subsequent tracking using supervised learning techniques like linear regression or random forests can forecast sustainability scores using historical data, such as power consumption or network traffic. Unsupervised learning methods, such as k-means clustering, can detect hidden patterns in network behavior and resource usage. To train the ML model 1026, a training dataset of various network devices with known attributes and measurement data 1030 can be utilized. Preprocessing and feature extraction may be performed to identify the most important data points. This refined data is used to train the ML model(s) 1026, allowing it to learn relevant patterns.

Once trained, the ML model 1026 may be integrated into the device 1000 to make real-time decisions or predictions for location and tracking of BKDs. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a location detection logic for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a network controller configured to provide access to a network and communicatively coupled to a set of peer network devices;
a processor; and
a memory communicatively coupled to the processor, wherein the memory comprises a location detection logic that is configured to:
transmit a tone sequence to excite a backscatter device (BKD);
receive, from at least one peer network device of the set of peer network devices, one or more phase difference values between the transmitted tone sequence received by the at least one peer network device and a reflected tone sequence the at least one peer network device received from the excited BKD; and
determine a location of the BKD based on the received one or more phase difference values.

2. The network device of claim 1, wherein prior to transmitting the tone sequence, the location detection logic is further configured to transmit an announcement frame.

3. The network device of claim 2, wherein the announcement frame comprises an identifier of the at least one peer network device and an identifier of the BKD.

4. The network device of claim 3, wherein the announcement frame corresponds to an indication to the at least one peer network device to participate in a location determination event of the BKD.

5. The network device of claim 3, wherein the announcement frame further comprises one or more of: a target time, a target channel, or a target duration.

6. The network device of claim 5, wherein based on the announcement frame comprising the target time, the location detection logic is further configured to transmit the tone sequence at the target time.

7. The network device of claim 5, wherein based on the announcement frame comprising the target duration, the location detection logic is further configured to transmit the tone sequence for the target duration.

8. The network device of claim 5, wherein based on the announcement frame comprising the target channel, the location detection logic is further configured to transmit the tone sequence on the target channel.

9. The network device of claim 3, wherein the announcement frame further comprises information corresponding to the tone sequence.

10. The network device of claim 9, wherein the information corresponding to the tone sequence comprises at least one of a frequency hopping pattern associated with the tone sequence, or a duration of symbols in each tone of the tone sequence.

11. The network device of claim 2, wherein the announcement frame comprises an action frame.

12. The network device of claim 1, wherein to transmit the tone sequence, the location detection logic is further configured to sequentially transmit a plurality of tones.

13. The network device of claim 12, wherein the plurality of tones comprises non-data bearing tones.

14. The network device of claim 12, wherein the plurality of tones is phase consistent.

15. A peer network device, comprising:
a processor;
a network interface controller configured to provide access to a network; and
a memory communicatively coupled to the processor, wherein the memory comprises a location detection logic that is configured to:
receive a tone sequence from a network device and a reflected tone sequence from a backscatter device (BKD);
determine one or more phase difference values between the received tone sequence and the received reflected tone sequence; and
transmit the one or more phase difference values to the network device.

16. The peer network device of claim 15, wherein prior to receiving the tone sequence and the reflected tone sequence, the location detection logic is further configured to receive an announcement frame comprising at least one of: a target time, a target duration, or a target channel associated with a location determination event of the BKD.

17. The peer network device of claim 16, wherein based on the announcement frame comprising the target time, the target duration, and the target channel, the location detection logic is further configured to transmit at the target time, a null frame with a duration field set for the target duration on the target channel.

18. The peer network device of claim 17, wherein based on receiving the announcement frame, the location detection logic is further configured to tune to the target channel at the target time, wherein the tone sequence and the reflected tone sequence are received on the target channel.

19. A backscatter device, comprising:
an antenna; and
a location detection logic that is configured to:
receive a tone sequence comprising a plurality of tones, wherein the plurality of tones is consistent in phase;
create, based on impedance modulation of the antenna, an on/off keying pattern in synchronization with the phase of the plurality of tones; and
reflect the tone sequence based on the on/off keying pattern.

20. The backscatter device of claim 19, wherein the backscatter device is a passive backscatter device that excites based on the received tone sequence.
